(19) United States
(12) Patent Application Publication
(10) Pub. No.: US 2014/0295281 A1
(43) Pub. Date: Oct. 2, 2014

(54) Lithiated Manganese Phosphate and Composite Material Comprising Same

(71) Applicants: Thibaut Gutel, Veurey-Voroize (FR); Etienne Radvanyi, Grenoble (FR)

(72) Inventors: Thibaut Gutel, Veurey-Voroize (FR); Etienne Radvanyi, Grenoble (FR)

(73) Assignee: COMMISSARIAT A L'ENEGIE ATOMIQUE ET AUZ ENERGIES AL TERNATIVES, Paris (FR)

(21) Appl. No.: 14/232,061

(22) PCT Filed: Jul. 11, 2012
(86) PCT No.: PCT/IB2012/053541

§ 371 Date: Mar. 6, 2014

(30) Foreign Application Priority Data
Jul. 12, 2011 (FR) 11 56340

(51) Int. Cl. H01M 4/136; H01M 4/62; C01B 25/45; H01M 4/58

(52) U.S. Cl. CPC H01M 4/136; H01M 4/5825; H01M 4/625; C01B 25/45
USPC 429/224; 427/122; 252/182.1

(57) ABSTRACT

The invention relates to a lithiated manganese phosphate and to a composite material comprising same. The lithiated manganese phosphate of the invention has formula I: Li₁₋ₓMn_{1-y}D_{y}PO₄, wherein D represents a dopant and 0≦x≦1.0≦y<0.15, and it is formed by non-agglomerated particles in the form of small plates. The invention is particularly suitable for use in the field of lithium batteries.

The invention relates to a lithiated manganese phosphate, a process for manufacturing it, and a composite material composed of particles of this coated manganese phosphate in carbon, and also to a process for synthesizing this composite material.

Lithium storage batteries are increasingly being used as a self-contained energy source, especially in portable devices, where they are gradually replacing the nickel-cadmium (Ni—Cd) and nickel-metal hydride (Ni-MH) storage batteries.

These lithium storage batteries are also called Li-ion storage batteries.

The increase in the use of Li-ion storage batteries is explained by the continued improvement in their performance, endowing them with mass and volume energy densities that are markedly superior to those provided by the Ni—Cd and Ni-MH storage batteries.

Accordingly, whereas the first Li-ion storage batteries possessed an energy density of approximately 85 Wh/kg, almost 200 Wh/kg can now be obtained (energy density relative to the mass of the complete Li-ion cell).

For comparison, the Ni-MH storage batteries where M is a metal go up to 100 Wh/kg, and the Ni—Cd storage batteries have an energy density of the order of 50 Wh/kg. The new generations of lithium storage batteries are already in development for applications which are increasingly diversified (hybrid or all-electric automobile, storage of energy from photovoltaic cells, etc.).

In order to respond to the increasingly greater energy demands (per unit mass and/or per unit volume), new electrode materials for Li-ion storage batteries that have even greater performance are vital.

The active compounds in the electrodes used in commercial storage batteries have, for the positive electrode, lamellar compounds such as LiCoO₂, LiNiO₂ and the mixed Li(Ni, Co, Mn, Al)O₂ compounds, or compounds with a spinel structure and a composition close to LiMn₂O₄. The negative electrode is generally carbon (graphite, coke, etc.) or possibly spinel, Li₄Ti₅O₁₂, or a metal which forms an alloy with lithium (Sn, Si, etc.). The theoretical and actual specific capacities of the positive electrode compounds cited are, respectively, approximately 275 mAh/g and 140 mAh/g for oxides of lamellar structure (LiCoO₂ and LiNiO₂), and 148 mAh/g and 120 mAh/g for the spinel compound LiMn₂O₄. In all these cases, an operating potential relative to metallic lithium of close to 4 volts is obtained.

Since lithium storage batteries emerged, a number of generations of positive electrode materials have successively appeared. The concept of inserting/extracting lithium into/from electrode materials was extended some years ago to three-dimensional structures constructed on the basis of polyanionic entities of type XOₙ^{m-} in which X=P, S, Mo, W, etc.; 2≦n≦4; and 2≦m≦4. The phosphates with an olivine structure and the general formula LiMPO₄ in which M is Fe, Mn, Co, or Ni, moreover, are currently experiencing a true upsurge. Among these four compounds of formula LiMPO₄, only lithiated iron phosphate, LiFePO₄, is currently capable of responding experimentally to the expectations, in view of a practical capacity which is now close to the theoretical value, namely 170 mAh/g. Nevertheless, this compound, emphasizing the electrochemical couple Fe³⁺/Fe²⁺, operates at 3.4 V vs Li⁺/Li. This low potential leads at maximum to a mass energy density of 580 Wh/kg of LiFePO₄. Conversely, it is known that phosphates of manganese, cobalt, and nickel, which are isotypical with LiFePO₄, exhibit higher potentials of extraction/insertion of lithium irons, of respectively 4.1 V, 4.8 V, and 5.1 V vs Li⁺/Li. The theoretical specific capacities of these three compounds are close to that of LiFePO₄. Conversely, from an experimental standpoint, important progress remains to be made in order to attain satisfactory practical specific capacity values.

Patent application US 2009/0117020 describes the synthesis of compounds of general formula LiₓM_{y}PO₄, where M may be Fe, Mn, Co, Ni, Ti, Cu, V, Mo, Zn, Mg, Cr, Al, Ga, B, Zr, and Nb, 0≦x≦1.2, and 0.8≦y≦1.2. These compounds are synthesized by microwave-assisted solvothermal synthesis.

Described more specifically in the examples is the synthesis of these compounds in a tetraethylene glycol solvent with microwave heating at 300° C. for 1 minute.

The resulting compounds have an olivine structure and, as shown in the figures, the form of nanosticks.

Document WO 2007/113624 also describes the solvothermal synthesis of lithiated metal phosphate, using a polyol cosolvent.

The process for manufacturing LiMPO₄ that is described in said document comprises heating (not by microwaves) of the starting compounds in a water/diethylene glycol mixture for 1 to 3 hours at 100 to 150° C. Said solvent is then removed to give an olivine-type crystal phase, and heat treatment in air at a temperature of between 300 and 500° C. for 30 minutes to 1 hour is applied.

European patent application 2 015 382 A1 in turn describes a process for preparing a carbon/lithiated manganese phosphate composite.

The compounds obtained have a layer of manganese at the carbon/lithiated manganese phosphate interface.

LiMPO₄ materials where M may be Co, Ni, Mn, or Fe, and more particularly the manganese phosphate LiMnPO₄, with an olivine structure, are of very great interest as active materials for a positive electrode, owing to their operating potentials, which are relatively high but which remain compatible with conventional electrolytes (4.1 V vs Li⁺/Li, in combination with a theoretical specific capacity of 171 mAh/g.

From a theoretical standpoint, for example, the compound LiMPO₄ possesses an energy density greater than the majority of positive electrode materials that are known (700 Wh/kg of LiMPO₄).

Nevertheless, the practical capacity of LiMPO₄ that has been reported in the literature is relatively mediocre. Moreover, the electrochemical curve of extraction/insertion of lithium ions in LiMPO₄ evinces very substantial polarization, primarily due to the low conductivity (electronic and/or ionic) of the material.

In this context, the subject matter of the present invention is to obtain new positive electrode materials for a lithium storage battery, having a specific capacity greater than the positive electrode material of the prior art.

More specifically, the aim of the invention is to provide a carbon/lithiated metal phosphate composite having an improved conductivity, a low electrochemical polarization, and a high specific capacity.

The inventors have now found that by using a particular method for synthesizing lithiated metal phosphates of type LiMnPO₄ and the composite C-LiMnPO₄, the metal phosphate having a specific morphology beneficial for the electrochemical performance of the composite.

The invention accordingly provides a lithiated manganese phosphate of formula I below:

Li₁₋ₓMn_{1-y}D_{y}PO₄

in which:
D represents a doping element,
0≦x<1
0≦y<0.15,
   characterized in that it is composed of nonagglomerated particles having the form of platelets in which two dimensions are between 100 nm and 1000 nm and in which the thickness is between 1 nm and 100 nm, and in that it has an olivine crystallographic structure.

The lithiated metal phosphate of the invention has a specific surface area of greater than 10 m²/g, preferably of greater than or equal to 20 m²/g, and typically less than 100 m²/g.

In one particularly preferred embodiment, the lithiated manganese phosphate has the formula I in which x=y=0.

The invention also provides a composite material composed of particles of lithiated manganese phosphate according to the invention described above, which are covered on their outer surfaces by a layer of carbon.

The layer of carbon preferably has a thickness of between 1 and 10 nm.

The composite material according to the invention preferably has a specific surface area of greater than 70 m²/g, preferably of greater than or equal to 80 m²/g.

The invention likewise proposes a process for synthesizing a lithiated phosphate according to the invention, characterized in that it comprises the following steps:
a) preparation of a mixture of a lithium precursor, a phosphate precursor, and a manganese precursor in a diethylene glycol/water mixture,
b) microwave-assisted heat treatment of the mixture obtained in step a) at a temperature of between 90° C. and 250° C., preferably of 160° C., for 1 to 30 minutes, preferably for 5 minutes, under a pressure of between 1 and 15 bar, preferably of less than 4 bar,
c) washing, with a washing solvent, of the particles obtained in step b),
d) removal of the washing solvent.

The invention also proposes a process for synthesizing a composite material according to the invention, which comprises steps a) to d), described above, of the process for synthesizing the lithiated phosphate according to the invention, followed by a step e) of coating of the particles obtained after step d) with carbon having a specific surface area of between 500 and 2000 m²/g, preferably of between 700 and 1500 m²/g.

In the process for synthesizing the lithiated manganese phosphate according to the invention and the composite according to the invention, the lithium precursor may be selected from lithium acetate (LiOAc.2H₂O), lithium hydroxide (LiOH.H₂O), lithium chloride (LiCl), lithium nitrate (LiNO₃), and lithium hydrogenphosphate (LiH PO₄).

With regard to the phosphate precursor, it is selected from ammonium hydrogenphosphate (NH₄H₂PO₄), diammonium hydrogenphosphate ((NH₄)₂HPO₄), phosphoric acid (H₂PO₄), and lithium hydrogenphosphate (LiH PO₄).

The manganese precursor is selected from manganese acetate (MnOAc₂.4H₂O), manganese sulfate (MnSO₄.H₂O), manganese chloride (MnCl₂), manganese carbonate (MnCO₃), manganese nitrate (MnNO₃.4H₂O), the manganese phosphate of formula Mnₐ(PO₄)_{b}.H₂O in which 1≦a≦3 and 1≦b≦4, and the manganese hydroxide of formula Mn(OH)_{c} in which c=2 or 3.

According to one advantageous embodiment of the invention, the precursor is manganese sulfate.

In the synthesis processes of the invention, the washing solvent is based on water, and is preferably a mixture of water and ethanol. More preferably the washing solvent in step c) is water.

With regard to step d), it is preferably an oven drying step at a temperature of between 50 and 70° C. More preferably it is an oven drying step at a temperature of 60° C.

With regard to step e) of coating particles of the lithiated manganese phosphate of the invention, in the process for synthesizing the composite according to the invention, the step is preferably an air-drying step for lithiated manganese phosphate particles with carbon, at ambient temperature.

This carbon is preferably carbon of the carbon black type.

The invention further proposes a positive electrode comprising at least 50% by weight, relative to the total weight of the electrode, of the composite material according to the invention or of the composite material obtained by the process according to the invention.

The invention relates, lastly, to a lithium storage battery comprising at least one electrode according to the invention.

The invention will be appreciated more fully, and other advantages and features thereof will emerge more clearly, from a reading of the explanatory description which follows and which is made with reference to the attached figures, in which:

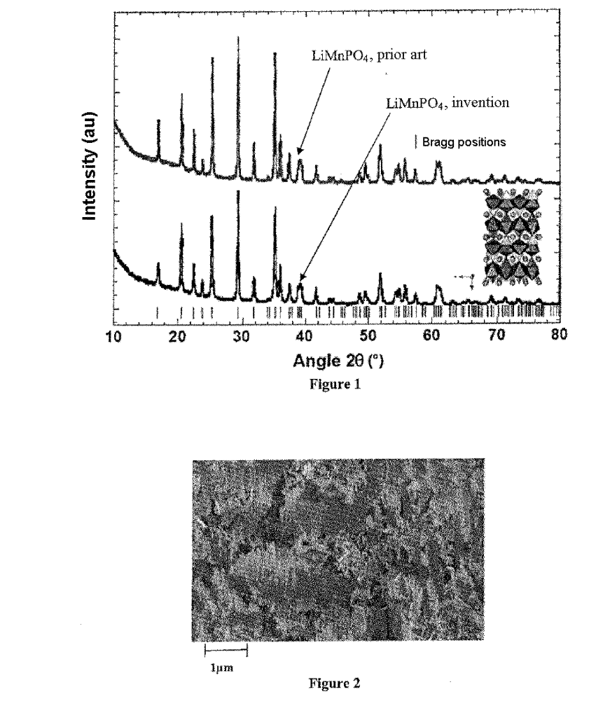

FIG. 1 represents the X-ray diffraction diagrams (λCuKα) of compounds of formula LiMnPO₄ prepared according to the invention and prepared according to the hydrothermal synthesis route;

FIG. 2 is an image obtained by scanning electron microscopy (FEG-SEM) of the compound LiMnPO₄ obtained by the process of the invention, at a magnification of 50 000;

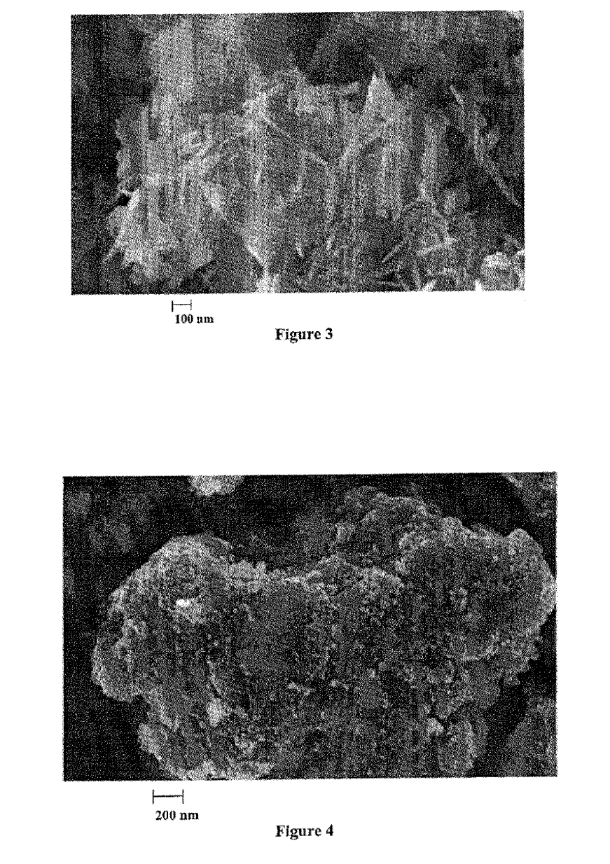

FIG. 3 shows the same LiMnPO₄ compound as in FIG. 2, but at a magnification of 200 000;

FIG. 4 represents an image obtained by field emission gun-scanning electron microscopy (FEG-SEM) of the final C-LiMnPO₄ composite prepared according to the process of the invention, at a magnification of 100 000;

FIG. 5 represents the same composite as in FIG. 4, but at a magnification of 300 000;

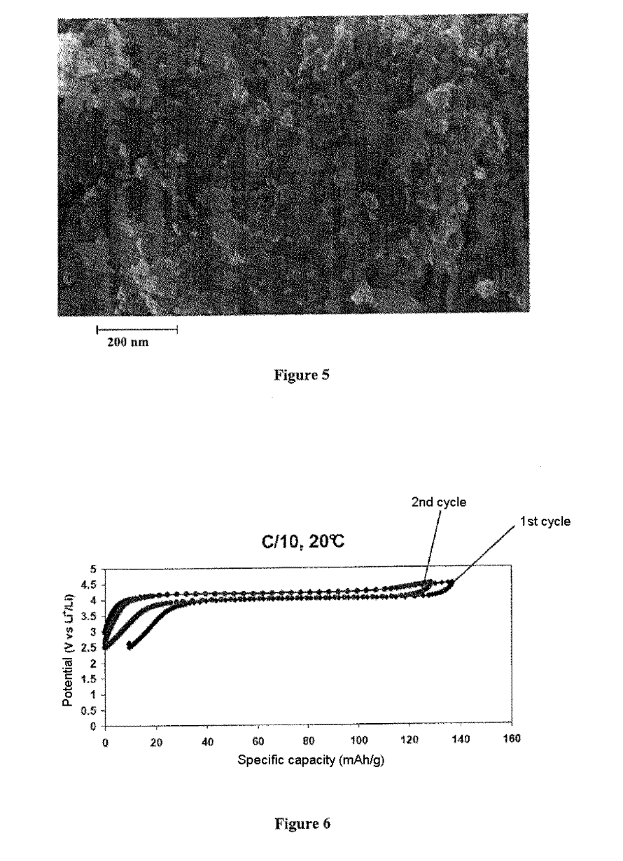

FIG. 6 is a graph representing the first two charge/discharge cycles in intentiostatic mode (C/10 regime; 20° C.) of the compound C-LiMnPO₄ (15% by mass of carbon) of between 2.5 and 4.5 V;

FIG. 7 represents the change in the specific capacity in discharge as a function of the number of cycles at a C/10 regime; 20° C., carried out in the case of the compound C-LiMnPO₄ of the invention of between 2.5 and 4.5 V;

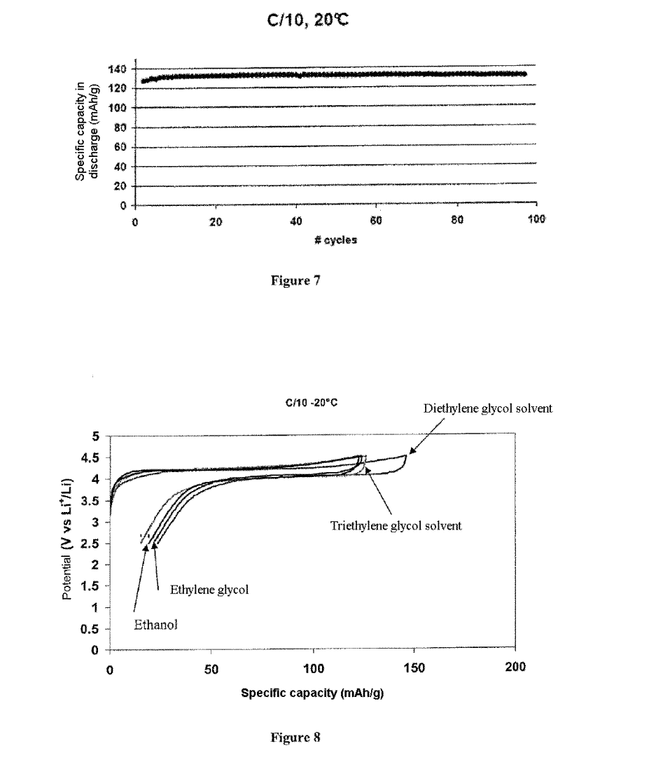

FIG. 8 is a graph representing the first two charge/discharge cycles in intentiostatic mode (C/10 regime; 20° C.) of C-LiMnPO₄ composites (15% by mass of carbon) prepared in different aqueous solvents containing different glycol compounds, of between 2.5 and 4.5 V, and

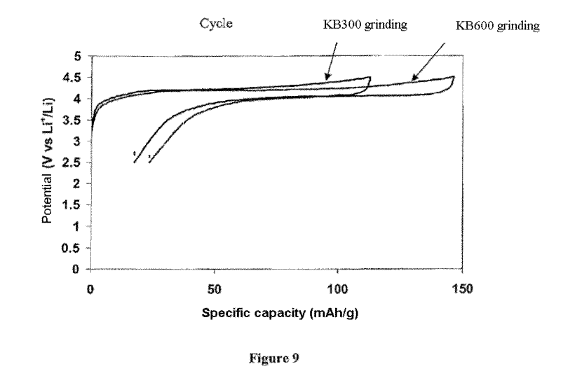

FIG. 9 is a graph representing the first two charge/discharge cycles in intentiostatic mode (C/10 regime; 20° C.) of C-LiMnPO₄ composites (15% by mass of Ketjen Black EC300J and EC300JD carbon) of between 2.5 and 4.5 V.

The theoretical capacity of the electrochemical couple LiMnPO₄/MnPO₄ is 171 mAh/g. The electrochemical potential of extraction/insertion of the lithium is approximately 4.1 V vs Li⁺/Li. These values lead to a mass energy density of 700 Wh/kg of LiMnPO₄. Following optimization, a positive electrode material of this kind ought to allow the assembly of 250 Wh/kg Li-ion storage batteries (conventional, graphite-based negative electrode), whereas what are presently the most high-performance commercial storage batteries have an energy density of approximately 200 Wh/kg, and the standard storage batteries have a density of the order of 160-180 Wh/kg.

A number of authors have reported their studies on the synthesis and electrochemical behavior of LiMnPO₄ during insertion/extraction of lithium. For example, C. Delacourt et al. [C. Delacourt et al., Chem. Mater., 16 (2004), 93-99] show that they succeeded in attaining a specific capacity in first discharge of 70 mAh/g of LiMnPO₄, or 41% of the theoretical capacity of the material.

The syntheses are generally carried out by a solid route at high temperature, greater than or equal to 600° C. Such temperatures have to be employed in order to allow the decomposition of the lithium, manganese, and phosphorus precursors, the complete formation reaction of the LiMnPO₄ product, and the total evaporation of the volatile species (carbonates, nitrates, ammonium, etc.).

Because of the presence of PO₄³⁻, P₂O₇⁴⁻, and PO₃ groups, the LiMPO₄ phosphates are relatively insulating from an electronic standpoint. This is why in situ (during the synthesis) or ex situ (post treatment step) deposition of carbon on the surface of the particles of active substance is often necessary in order to obtain high electrochemical performance. The carbon has a twofold use: to increase the electron conductivity, and to limit the agglomeration of the particles under the effect of the synthesis temperature. This deposition of carbon is formed generally by thermal decomposition in a reductive atmosphere of an organic substance, simultaneously with the synthesis of the compound. In spite of the use of carbon, the electrochemical performance of LiMnPO₄ as reported in the literature drops rapidly during cycling with a high regime. In an article, S. K. Martha et al. [S. K. Martha et al. J. Electrochem. Soc., 156 (2009) 541-522] very recently obtained a specific capacity in first discharge of 145 mAh/g at a C/10 regime. Nevertheless, only 70 mAh/g remained at a 5C regime. To accomplish this, these authors had to use a very substantial amount of carbon (20% by mass), with consequently great detriment to the mass and volume energy densities of the electrode, and hence of the storage battery.

In all of these studies, the polarization (or internal resistance of the electrochemical cell) is relatively high. Such a characteristic is indicative of a poor conductivity (ionic and/or electronic) and is generally associated with poor electrochemical performance.

Although it is difficult to carry out low-temperature preparation of lithiated metal phosphates with an olivine crystallographic structure, which are electrochemically active, a process has now been found for synthesizing these compounds, and more particularly the compound LiMnPO₄, which allows the excessive growth of the particles or the formation of agglomerates to be limited maximally.

More particularly, in this process, the unwanted species such as the sulfates and hydroxides are removed at the end of synthesis, other than by evaporation in an oven, by a heat treatment at high temperature (of the order of 300° C.)

Moreover, the synthesis process of the invention employs a simple, rapid, and low-energy reaction in air, and produces a compound having a specific morphology.

More specifically, the synthesis process of the invention produces lithiated manganese phosphates of formula I below:

Li₁₋ₓMn_{1-y}D_{y}PO₄

in which:
D represents a doping element,
0≦x<1
0≦y<0.15,
   characterized in that it is composed of nonagglomerated particles having the form of platelets in which two dimensions are between 100 nm and 1000 nm and in which the thickness is between 1 nm and 100 nm, and in that it has an olivine crystallographic structure.

This lithiated manganese phosphate is a first subject of the invention.

This lithiated manganese phosphate preferably has a specific surface area of greater than 10 m²/g, and more preferably a specific surface area of greater than or equal to 20 m²/g, typically of between 25 and 35 m²/g.

The synthesis process of the invention is a microwave-assisted process producing a compound of formula I and more particularly the manganese phosphate LiMnPO₄.

The preparation of the compounds of formula I employs a first step of solvothermal synthesis in a microwave reactor, starting from a manganese precursor, a lithium precursor, and a phosphate precursor.

The various lithium precursors which may be used are as follows: lithium acetate (LiOAc.2H₂O), lithium hydroxide (LiOH.H₂O), lithium chloride (LiCl), lithium nitrate (LiNO₃), and lithium hydrogenphosphate (LiH₂PO₄).

In the case of the synthesis of LiMnPO₄, the lithium precursor is preferably hydrated lithium hydroxide, LiOH.H₂O.

The various phosphorus precursors which may be used are as follows: ammonium hydrogenphosphate (NH₄H₂PO₄), diammonium hydrogenphosphate ((NH₄)₂HPO₄), phosphoric acid (H₂PO₄), and lithium hydrogenphosphate (LiH₂PO₄).

When the metal M is manganese, various precursors may be used. These precursors are as follows: manganese acetate (MnOAc₂.4H₂O), manganese sulfate (MnSO₄.H₂O), manganese chloride (MnCl₂), manganese carbonate (MnCO₃), manganese nitrate (MnNO₃.4H₂O), the manganese phosphate of formula Mnₐ(PO₄)_{b}.H₂O in which 1≦a≦3 and 1≦b≦4, and the manganese hydroxide of formula Mn(OH)c in which c=2 or 3.

With regard to the optional doping elements, they may be vanadium, boron, aluminum, magnesium, etc.

They may be present in amounts of between 0 and 15 mol %, preferably between 0 and 5 mol %, relative to the number of moles of manganese present in the compound of the invention.

The various precursors are introduced in stoichiometric amounts into the microwave reactor.

Where the lithium precursor is LiOH.H₂O, however, it is advantageous to use an excess of lithium, relative to the stoichiometric amount. Hence three equivalents of lithium are used with preference.

This first step of solvothermal synthesis takes place in a water/diethylene glycol mixture in a ratio of 1/4 by volume.

This is a diethylene glycol/water mixture comprising between 50% and 90% of diethylene glycol, by volume, relative to the total volume of the mixture, the remainder being advantageously composed of water. The mixture preferably contains of the order of 80%±5%, by volume, of diethylene glycol.

According to the invention, the diethylene glycol/water mixture does not comprise other glycols, and more particularly not triethylene glycol or tetraethylene glycol.

The temperature during this first step is between 90 and 250° C., being preferably 160° C., and the pressure in the reactor is between 1 and 15 bar, but lower than 4 bar.

The power of the microwave oven is set depending on the mass of the sample to be treated (400, 800, or 1600 W). The temperature of the reaction mixture is maintained for a time of between 1 and 30 minutes, preferably for 5 minutes.

In a second step, the compound of formula I obtained is simply washed with ethanol and with water to remove the solvents and the residual sulfates, then dried in an oven under air at a temperature of between 50 and 60° C.

To obtain the composition of the invention, the third step is to carry out intimate mixing by energetic grinding in air and at ambient temperature of the particles of the compound of formula I that were prepared before, with a carbon having a high specific surface area, preferably of greater than 700 m²/g, such as the carbon Ketjen Black® ec600j.

By energetic grinding is meant grinding in a planetary ball mill, in this case a Retsch® S100 mill at 500 revolutions/minute in a 50 mL agate bowl, equipped with 20 agate balls with a diameter of 1 cm.

The manganese concentration of the solution in the first step is selected between 0.1 to 1 mol/L, and the pH of this solution is between 10 and 11.

With the process of the invention, the compound of formula I obtained has a “platelet” morphology, as shown in FIGS. 2 and 3.

As is seen in FIGS. 2 and 3, the compound of formula I takes the form of particles with little or no agglomeration, having a platelet shape, in which two of the dimensions are between 100 nm and 1000 nm and in which the thickness is between 1 nm and 100 nm. The thickness is preferably between 10 and 35 nm.

The compound of formula I has an olivine structure. This structure is shown in the box in FIG. 1.

FIG. 1 represents the X-ray diffraction spectrum of an LiMnPO₄ compound obtained by the process of the invention, and the X diffraction spectrum of an LiMnPO₄ compound obtained according to the synthesis process described in patent application WO 2007/113624. It is observed that the compound according to the invention is devoid of impurities.

The LiMnPO₄ manganese phosphate of the invention crystallizes in the Pnma space group.

The lattice parameters are of the order of 10.44 Å for the parameter a, of 6.09 Å for the parameter b, and of 4.75 Å for the parameter c. This compound has an olivine structure. This structure consists of a compact hexagonal stacking of oxygen atoms. The lithium ions and manganese ions are located in half of the octahedral sites, while phosphorus occupies ⅛ of the tetrahedral sites. A simplified representation of the structure of LiMnPO₄ is represented in the box in FIG. 1.

Still as seen in FIGS. 2 and 3, which represent particles of LiMnPO₄ obtained by the process of the invention, the resulting particles of LiMnPO₄ have a flattened morphology and nanometric sizes. The specific surface area of these particles is greater than 10 m²/g.

The specific surface areas indicated here were measured by BET.

The lithiated manganese phosphate of the invention may subsequently be covered, on its outer surfaces, with a layer of carbon, to give a carbon-lithiated manganese phosphate composite having improved conductivity and capacity properties.

The composite material of the invention has a specific surface area of greater than 70 m²/g, more preferably greater than or equal to 80 m²/g.

The layer of carbon in the composite of the invention preferably has a thickness of between 1 and 10 nm.

This composite material is shown in FIGS. 4 and 5.

The composite of the invention may be prepared by a process comprising the steps of synthesizing the lithiated manganese phosphate according to the invention, followed by a step of coating the lithiated magnesium phosphate particles obtained by the process of the invention, with carbon having a specific surface area of between 500 and 2000, preferably between 700 and 1500 m²/g.

Accordingly, the process for synthesizing the composite material according to the invention may comprise steps of synthesis of the lithiated manganese phosphate according to the invention, and in that case the same lithium, manganese, and phosphate precursors will be used as in the process for synthesizing the lithiated manganese phosphate of the invention, followed by a step of coating the lithiated manganese phosphate particles according to the invention with carbon, or the process for synthesizing the composite according to the invention may comprise only the step of coating of the lithiated manganese phosphate particles obtained by the process according to the invention, said particles having been prepared beforehand.

It is well known that the phosphates of transition elements generally have a low intrinsic conductivity. The composite of the invention or obtained by the process of the invention, by virtue of its specific morphology and its uniform coating with a layer of carbon, allows high capacities to be delivered, although its use is limited to relatively weak charge/discharge regimes.

The invention also relates to a positive electrode comprising a composite material according to the invention, and to lithium storage batteries comprising such an electrode.

The electrodes according to the invention may be applied to metal foils serving as current collectors, and are composed preferably of a dispersion of the composite material of the invention in an organic binder which imparts satisfactory mechanical strength.

From a practical standpoint, the positive electrode composed primarily of the composite of the invention or obtained by the process of the invention may be formed by any type of known means. As an example, the positive electrode material may be in the form of an intimate dispersion comprising, inter alia, and primarily, the composite of the invention and an organic binder.

The organic binder, which is intended to provide effective ionic conduction and a satisfactory mechanical strength, may be composed, for example, of a polymer selected from polymers based on methyl methacrylate, acrylonitrile, and vinylidene fluoride, and also polyethers or polyesters, or else carboxymethylcellulose.

Lithium storage batteries containing a composite material prepared by the process of the invention at the positive electrode may be constructed and operated.

In the storage batteries according to the invention, a mechanical separator between the two electrodes is impregnated with electrolyte (ionically conducting) composed of a salt whose cation is at least partly the lithium ion, and of a polar aprotic solvent, which may be an organic solvent such as a carbonate or a mixture of carbonates (diethyl carbonate, ethyl carbonate, vinyl carbonate, etc.) or a solid polymeric composite, PEO (polyethylene oxide), PAN (polyacrylonitrile), PMMA (polymethyl methacrylate), PVDF (polyvinylidene fluoride), or a derivative thereof.

The storage batteries according to the invention have good electrical characteristics, principally in terms of polarization (difference in potential between the charge curve and the discharge curve) and of specific capacity recovered in discharge.

This dispersion is subsequently applied to a metal foil serving as a current collector, made of aluminum, for example.

The negative electrode of the Li-ion storage battery may be composed of any known type of material. As the negative electrode is not a source of lithium for the positive electrode, it must be composed of a material that is able initially to accept the lithium ions extracted from the positive electrode, and to restore them subsequently. For example, the negative electrode may be composed of carbon, most often in the form of graphite, or of a material of spinel structure such as Li₄Ti₅O₁₂. Accordingly, in an Li-ion storage battery, the lithium is never in metallic form. It is the Li⁺ cations that go back and forth between the two lithium insertion materials of negative and positive electrodes, on each charging and discharging of the storage battery. The active materials of the two electrodes are generally in the form of an intimate dispersion of said lithium insertion/extraction material with an electron-conducting additive and optionally an organic binder as mentioned above.

Finally, the electrolyte of the lithium storage battery made from the lithiated metal phosphate or from the composite of the invention is composed by any known type of material. It may be composed, for example, of a salt comprising at least the cation Li⁺. The salt is, for example, selected from LiClO₄, LiAsF₆, LiPF₆, LiBF₄, LiRFSO₃, LiCH₃SO₃, LiN(RFSO₂)₂, LiC(RFSO₂)₃, LiTFSI, LiBOB, LiBETI. RF is selected from a fluorine atom and a perfluoroalkyl group comprising between one and eight carbon atoms. LiTFSI is the acronym of lithium trifluoromethanesulfonylimide, LiBOB is that of lithium bis(oxalato)borate, and LiBETI is that of lithium bis(perfluoroethylsulfonyl)imide. The lithium salt is preferably dissolved in a polar aprotic solvent and may be supported by a separating element disposed between the two electrodes of the storage battery; in that case, the separating element is impregnated with electrolyte. In the case of an Li-ion storage battery with polymeric electrolyte, the lithium salt is not dissolved in an organic solvent, but in a solid polymeric composite such as PEO (polyethylene oxide), PAN (polyacrylonitrile), PMMA (polymethyl methacrylate), PVDF (polyvinylidene fluoride), or a derivative thereof.

For better understanding of the invention, an example of its implementation will now be described, as a purely illustrative and nonlimitative example.

### EXAMPLE 1

### Synthesis of LiMnPO₄

1.15 g of manganese sulfate monohydrate (MnSO₄.H₂O) are dissolved in 10 mL of distilled water (giving a manganese concentration of 0.15 mol/L).

0.44 mL of aqueous 85% phosphoric acid (H₃PO₄) solution is added with magnetic stirring, followed by 0.82 g of lithium hydroxide monohydrate (LiOH.H₂O, or 3 equivalents).

A precipitate then forms rapidly, starting from the beginning of addition of the lithium salt.

Following addition of 40 mL of diethylene glycol (DEG), the suspension is introduced into a sealed 100 mL reactor suitable for microwaves.

The temperature is then raised to 160° C. for 5 minutes in the microwave oven at a power of 400 W.

The final (colorless) solution contains a white-color precipitate.

The precipitate is washed with water and ethanol and is centrifuged and dried at 60° C. for 24 h.

The powder recovered, which is white in color, has the composition LiMnPO₄.

The X-ray diffraction spectrum of this compound is represented in FIG. 1 (upper curve).

The morphology of this compound is represented in FIGS. 2 and 3.

Then 850 mg of this compound are introduced into an agate grinding bowl containing 150 mg of amorphous Ketjen Black EC660J® carbon with a specific surface area of 1300 m²/g.

The mixture is subsequently ground at 500 rpm in air and at ambient temperature for 4 h.

### COMPARATIVE EXAMPLE 1

The synthesis of LiMnPO₄ in this example was carried out as in example 1, but replacing the diethylene glycol with ethanol.

### COMPARATIVE EXAMPLE 2

The procedure was as in example 1, but replacing the diethylene glycol with ethylene glycol.

### COMPARATIVE EXAMPLE 3

The procedure was as in example 1, but replacing the diethylene glycol with triethylene glycol.

### EXAMPLE 2

A lithium storage battery of “button cell” format is assembled with:
a negative lithium electrode (16 mm in diameter, 130 μm in thickness) applied to a nickel disc serving as current collector,
a positive electrode consisting of a disc with a diameter of 14 mm, taken from a composite film with a thickness of 25 μm, comprising the composite material of the invention prepared according to example 1 (90% by mass) and polyvinylidene fluoride (10% by mass) as binder, the whole being applied to an aluminum current collector (foil with a thickness of 20 micrometers),
a separator impregnated with a liquid electrolyte based on the salt LiPF₆ (1 mol/L) in solution in a mixture of propylene carbonate and dimethyl carbonate.

At 20° C., in a C/10 regime, this system allows most of the lithium present in the positive electrode material to be extracted, as shown in FIG. 7 on the curve indicated “KB600 grinding”. From this figure and from FIG. 6 it is seen that the lithiated phosphate compound of the invention is stable for up to at least one hundred cycles.

### EXAMPLE 3

1.15 g of manganese sulfate monohydrate (MnSO₄.H₂O) are dissolved in 10 mL of distilled water (giving a manganese concentration of 0.15 mol/L). 0.44 mL of aqueous 85% phosphoric acid (H₃PO₄) solution is added with magnetic stirring, followed by 0.82 g of lithium hydroxide monohydrate (LiOH.H₂O, or 3 equivalents). A precipitate then forms rapidly, starting from the beginning of addition of the lithium salt. Following addition of 40 mL of diethylene glycol, the suspension is subsequently introduced into a sealed 100 mL reactor suitable for microwaves, and is treated at 160° C. for 5 minutes in a CEM oven (power of 400 W). The final (colorless) solution contains a white-color precipitate. This precipitate is washed with water and ethanol, and is centrifuged and dried at 60° C. for 24 h. The powder recovered, with a white color, has the composition LiMnPO₄.

850 mg of this powder are subsequently introduced into an agate grinding bowl containing 150 mg of amorphous Ketjen Black EC300J® carbon. The mixture is subsequently ground for 4 h at 500 rpm. The Ketjen Black EC300J® carbon has a specific surface area of 1300 m²/g.

### EXAMPLE 4

A lithium storage battery of “button cell” format is assembled with:
a negative lithium electrode (16 mm in diameter, 130 μm in thickness) applied to a nickel disc serving as current collector,
a positive electrode consisting of a disc with a diameter of 14 mm, taken from a composite film with a thickness of 25 μm, comprising the material of the invention prepared according to example 3 (90% by mass) and polyvinylidene fluoride (10% by mass) as binder, the whole being applied to an aluminum current collector (foil with a thickness of 20 micrometers),
a separator impregnated with a liquid electrolyte based on the salt LiPF₆ (1 mol/L) in solution in a mixture of propylene carbonate and dimethyl carbonate.

At 20° C., in a C/10 regime, this system allows most of the lithium present in the positive electrode material to be extracted, as shown in FIG. 9 on the curve labeled KB300 grinding.

### COMPARATIVE EXAMPLE 5

Lithium storage batteries were prepared as by the method described in example 2, but using, respectively, the compounds obtained in comparative examples 1 to 3.

As shown in FIG. 8, these storage batteries, at 20° C., under a C/10 regime, have a poorer specific capacity than the storage batteries assembled with the compound of example 1.

In FIG. 8, the curve indicated “Diethylene glycol solvent” corresponds to the curve obtained with the compound according to the invention from example 1, the curve labeled “Triethylene glycol solvent”, corresponds to the curve obtained with the compound according to comparative example 3, the curve labeled “Ethylene glycol” corresponds to the curve obtained with the storage battery assembled with the composite from comparative example 2, and the curve labeled “Ethanol” corresponds to the curve obtained with a storage battery assembled with the composite obtained in comparative example 1.

1. A lithiated manganese phosphate of formula I below:
Li₁₋ₓMn_{1-y}D_{y}PO₄
in which:
D represents a doping element,
0≦x<1
0≦y<0.15,
wherein the lithiated maganese phosphate is composed of nonagglomerated particles having the form of platelets in which two dimensions are between 100 nm and 1000 nm and in which the thickness is between 1 nm and 100 nm, and it has an olivine crystallographic structure.

2. The lithiated manganese phosphate as claimed in claim 1, having a specific surface area of greater than 10 m²/g.

3. The lithiated manganese phosphate as claimed in claim 1, wherein in the formula I, x=y=0.

4. A composite material composed of particles of the lithiated manganese phosphate as claimed in claim 1, covered on their outer surfaces by a layer of carbon.

5. The composite material as claimed in claim 4, having a specific surface area of greater than 70 m²/g.

6. The composite material as claimed in claim 4, wherein the layer of carbon has a thickness of between 1 and 10 nm.

7. A process of synthesizing a lithiated manganese phosphate as claimed in claim 1, having the formula I below:
Li₁₋ₓMn_{1-y}D_{y}PO₄
in which:
D represents a doping element,
0≦x<1
0≦y<0.15,
comprising the following steps:
a) preparation of a mixture of a lithium precursor, a phosphate precursor, a precursor of the element manganese, and optionally of the doping element, in a diethylene glycol/water mixture,
b) microwave-assisted heat treatment of the mixture obtained in step a) at a temperature of between 90° C. and 250° C., for 1 to 30 minutes,
c) washing, with a washing solvent, of the particles obtained in step b), and
d) removal of the washing solvent.

8. A process of synthesizing a composite material as claimed in claim 4, comprising steps a) to d) of the process as claimed in claim 7, and a step e) of coating of the particles obtained after step d) with carbon having a specific surface area of between 500 and 2000.

9. The process as claimed in claim 7, wherein the lithium precursor is selected from lithium acetate (LiOAc.2H₂O), lithium hydroxide (LiOH.H₂O), lithium chloride (LiCl), lithium nitrate (LiNO₃), and lithium hydrogenphosphate (LiH₂PO₄).

10. The process as claimed in claim 7, wherein the phosphate precursor is selected from ammonium hydrogenphosphate (NH₄H₂PO₄), diammonium hydrogenphosphate ((NH₄)₂HPO₄), phosphoric acid (H₃PO₄), and lithium hydrogenphosphate (LiH₂PO₄).

11. The process as claimed in claim 7, wherein the manganese precursor is selected from manganese acetate (MnOAc₂.4H₂O), manganese sulfate (MnSO₄.H₂O), manganese chloride (MnCl₂), manganese carbonate (MnCO₃), manganese nitrate (MnNO₃.4H₂O), the manganese phosphate of formula Mnₐ(PO₄)_{b}.H₂O) in which 1≦a≦3 and 1≦b≦4, and the manganese hydroxide of formula Mn(OH)_{c} in which c=2 or 3.

12. The process as claimed in claim 8, wherein step e) is a step of air grinding of the particles obtained in step d) with carbon, at ambient temperature.

13. The process as claimed in claim 8, characterized in that the carbon is carbon black.

14. A positive electrode characterized in that it comprises at least 50% by mass, relative to the total mass of the electrode, of the composite material as claimed claim 4 or of the composite material obtained by the process as claimed in claim 8.

15. A lithium storage battery comprising at least one electrode as claimed in claim 14.

16. The lithiated manganese phosphate as claimed in claim 1, having a specific surface area of greater than 20 m²/g.

17. The composite material as claimed in claim 4, having a specific surface area of greater than 80 m²/g.

18. A process as claimed in claim 8, wherein the specific surface area is between 700 and 1500 m²/g.
